(19) United States
(12) Patent Application Publication
(10) Pub. No.: US 2009/0164785 A1
(43) Pub. Date: Jun. 25, 2009

(54) METHOD FOR AUTHENTICATION IN A COMMUNICATION NETWORK

(75) Inventors: ANTHONY R. METKE, NAPERVILLE, IL (US); DONALD E. EASTLAKE, III, MILFORD, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/960,757

(22) Filed: Dec. 20, 2007

(51) Int. Cl. H04L 9/32

(52) U.S. Cl. 713/169

(57) ABSTRACT

A method authenticates a first node to a communication network that includes a second node to which the first node desires to mutually authenticate. The method includes detecting a broadcast message from the second node and determining whether mutual authentication can be performed directly with the second node. When the first node is unable to mutually authenticate to the second node directly, the first node locates a node that can serve as an authentication bridge to authenticate the first node to the communication network.

### FIELD OF THE DISCLOSURE

The present invention generally relates to communication networks and more particularly to a method for authenticating nodes to a communication network.

### BACKGROUND

Mobile nodes such as personal digital assistants (PDAs), cellular phones, and notebook computers often require authentication when accessing remote communication networks. When a node seeks to communicate securely with another node that is operating in a communication network, it must establish a trust relationship with that node. In order to establish the trust relationship, both nodes must have the proper security credentials in order to mutually authenticate to each other for the purpose of secure exchange of messages within the communication network. However, if the nodes don't initially possess these security credentials, a third node having the proper security credentials for both nodes can serve as an authentication bridge to assist the nodes in their mutual authentication process.

In some communication networks, such as those having limited or no infrastructure connectivity, problems arise in quickly forming trust relationships between nodes. First, it may be difficult for the nodes to quickly and conveniently determine whether they possess the proper security credentials for mutual authentication. This is because known techniques, such as using a Service Set Identifier (SSID), used to indicate a likelihood of success in mutual authentication are not sufficient in certain communication networks. Moreover, upon nodes determining that they are unable to successfully complete the mutual authentication process, suitable techniques do not exist in some communication networks to find an authentication bridge.

Thus there exists a need for methods to authenticate a node to a communication network.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a schematic diagram of wireless networks in accordance with some embodiments.

FIG. 2 is a flow diagram from a perspective of a node operating in a wireless network illustrating a method for authenticating the node to a wireless network and to a node which is operating in the wireless network in accordance with some embodiments.

FIG. 3 is a flow diagram from a perspective of a first node illustrating a method for authenticating the first node to a wireless network and to a second node which is operating in the wireless network in accordance with some embodiments.

FIG. 4 is a signal flow diagram illustrating the first node mutually authenticating to the wireless network and to the second node with the help of a node that serves as an authentication bridge in accordance with some embodiments.

FIG. 5 is a flow diagram illustrating a method for locating an authenticating bridge in accordance with some embodiments.

FIG. 6 is a block diagram illustrating the first node authenticating to the second node with the help of an authentication bridge in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to various embodiments, a first node desires to communicate with a second node that is a part of a communication network. The communication network can be a wireless network or a wireline network. Any node that is outside or inside the communication network broadcasts messages that comprise an indication of cryptographic secrets for at least the broadcasting node and in some instances for one or more neighbor nodes to the broadcasting node. The indication of cryptographic secrets includes an indication of a trust anchor or a key or both, which assists nodes in determining whether they possess the proper security credentials for a successful mutual authentication. The first node receives a broadcast message from the second node. The first node determines from the indication of cryptographic secrets for the second node (contained in the broadcast message) whether it can mutually authenticate directly with the second node.

If the first node cannot mutually authenticate directly with the second node, it locates a third node that can serve as an authentication bridge by sending out a request for an authentication bridge including therein parameters to locate the authentication bridge. These parameters can include an indication of the cryptographic secrets for both the first and second nodes. Upon identifying from the request message the indications of cryptographic secrets for the first and second nodes, a receiving node can confirm that it can serve as the authentication bridge. The located authentication bridge mutually authenticate to both the first and second nodes and sends both nodes required keying material. The first and second nodes use the shared keying material to complete their mutual authentication process and, thereby, authenticate the first node to the communication network. As stated above, the embodiments can be applied to both wireless and wireline networks. However, the specific implementations described herein are directed to wireless networks for illustrative purposes only.

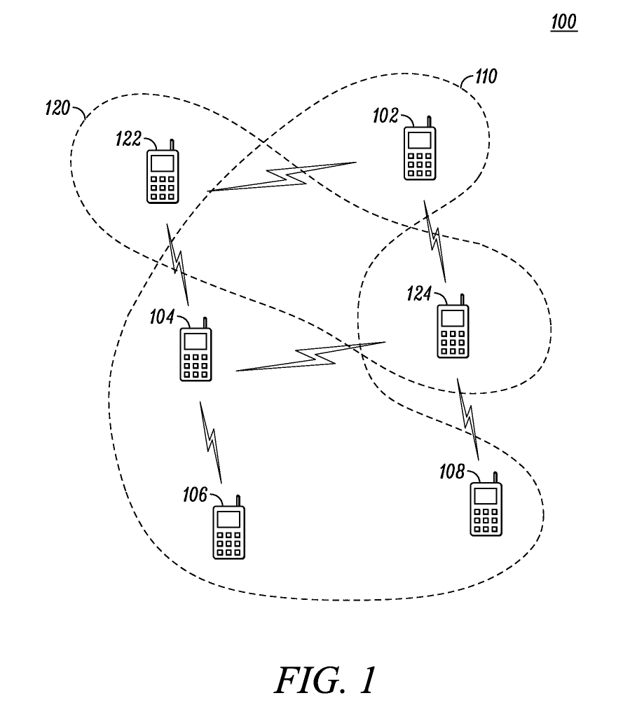

FIG. 1 illustrates a schematic diagram 100 of wireless networks in accordance with some embodiments. As shown in FIG. 1, there is a plurality of wireless networks including a wireless network 110 and a wireless network 120. The wireless network 110 includes a plurality of nodes, e.g., nodes 102, 104, 106 and 108. Similarly, the wireless network 120 also includes a plurality of nodes, e.g., nodes 122 and 124. As used herein, the term node is any device capable of operating in a wireless environment. Examples of nodes include, but are not limited to a laptop, a personal digital assistant (PDA), a mobile phone, a pager, a sensor or any other communication device. The aforementioned wireless networks are not restricted to the number of nodes mentioned, and they can include any finite number of nodes. The teachings herein are also applicable when there are more than two networks, although only two networks are shown in FIG. 1 for clarity.

A node operating in one wireless network may desire to communicate with a node operating in a different wireless network. For instance, the node 104 operating in the wireless network 110 desires to communicate with the node 124 operating in the wireless network 120. In secure networks, before such communication can begin, nodes 104 and 124 establish a trust relationship, which can be done using a mutual authentication process implemented using any suitable protocol, such as Extensible Authentication Protocol (EAP). During the mutual authentication process, both entities (104 and 124 in this instance) use their security credentials to provide assurance of their identity, thus, providing assurance that each can legitimately communicate on the network. Security credentials include, but are not limited to, keying material (e.g., public or private keys), cryptographic secrets, digital certificates or any other parameters that may be used to facilitate secure message exchange in a network. Cryptographic secrets include, but are not limited to, shared symmetric private keys, asymmetric private key parts, private key pairs, or any other security credential that is kept secret and cannot be transmitted in the clear without compromising the security of the network. Cryptographic secrets are distinguishable from other security credentials, such as digital certificates, public keys, etc., that do not need to be maintained as secret.

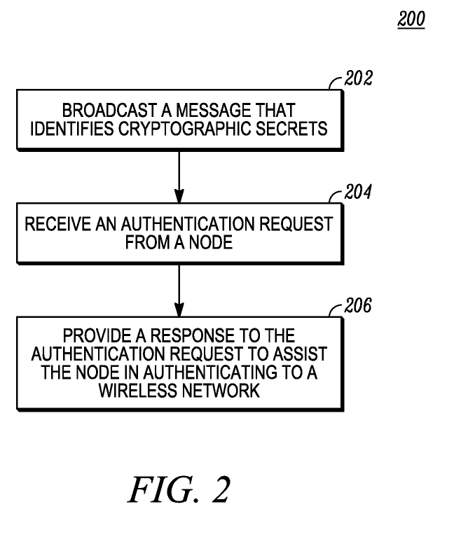

Because the message exchange for mutual authentication can be a lengthy process, it is useful to have an indication before initiating the mutual authentication process whether it is likely to be successful. In accordance with the teachings herein, generally described by reference to FIG. 2, an indication of cryptographic secrets included in broadcast messages can be used to quickly determine whether mutual authentication can be directly performed between two nodes. The “indication” of the cryptographic secrets is used so as not to disclose the actual cryptographic secret, thereby compromising the security of the network. Where direct mutual authentication cannot initially be performed, indications of cryptographic secrets can be further used to locate an authentication bridge to assist with the mutual authentication process to authenticate a node to a network.

More particularly, with regards to a method 200 illustrated in FIG. 2, any node (e.g., some or all of the nodes in the networks 110 and 120) can broadcast (202) messages to a plurality of other nodes, wherein the broadcast messages comprise an indication of its cryptographic secrets and in some implementations an indication of the cryptographic secrets of one or more other nodes. Other nodes receiving these broadcast messages can determine whether that node shares appropriate security credentials and can participate in an authentication process. For example, in one scenario the broadcasting node is a node with which the receiving node can directly mutually authenticate. In another scenario, the broadcasting node has the security credentials to serve as an authentication bridge for the receiving node.

The receiving node, upon determining that the indication of cryptographic secrets in the broadcast message should enable the broadcasting node to participate in the authentication process, requests such participation of the broadcasting node via an authentication request. The broadcasting node receives (204) the authentication request, and provides (206) a positive or negative response to the authentication request to the requesting node that it will participate in the authentication process for the requesting node.

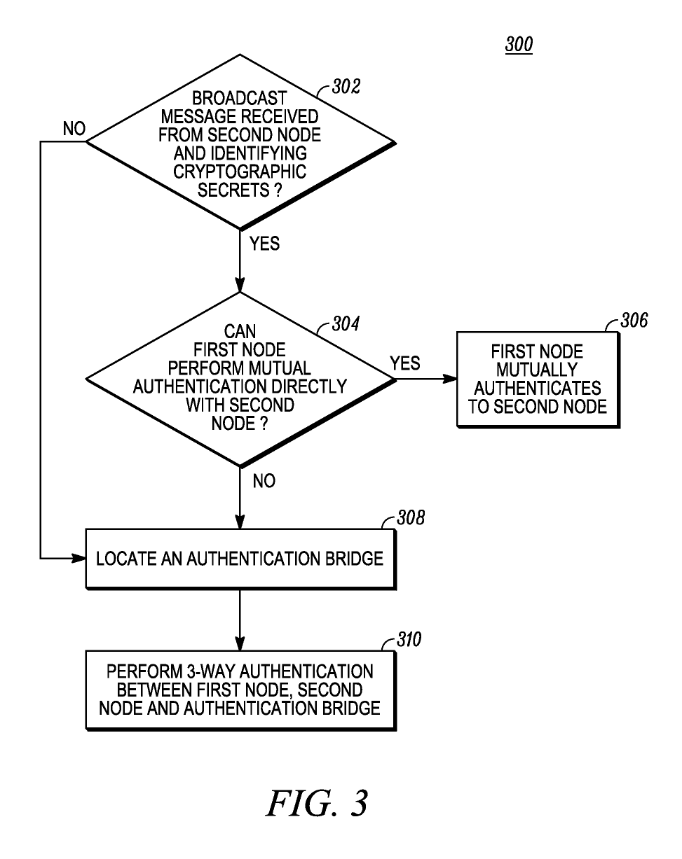

Turning now to FIG. 3, a flow diagram from a perspective of a node (e.g., the node 104) illustrating a method for authenticating the node to a wireless network and to a node (e.g., the node 124) that is operating in the wireless network in accordance with some embodiments is shown and indicated at 300. Method 300 generally describes how the indication of cryptographic secrets for the nodes can be used to ultimately facilitate authentication of a node to a wireless network either via direct mutual authentication or via an authentication process (e.g., a three-way authentication process) that involves an authentication bridge.

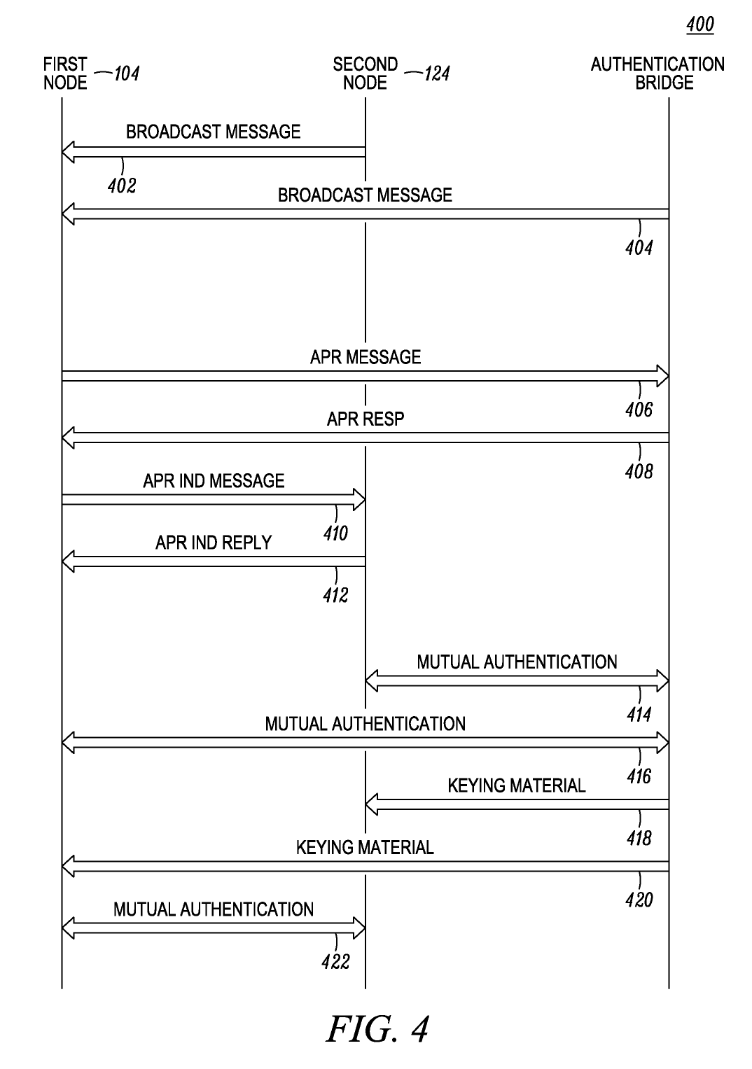

In general, the method 300 comprises a first node: receiving (302) a broadcast message from a second node and identifying an indication of cryptographic secrets for the second node; determining (304) from the indication of cryptographic secrets whether the first node can perform mutual authentication directly with the second node; if the first node can perform mutual authentication directly with the second node, then the first node mutually authenticates (306) to the second node, otherwise an authentication bridge is located (308) for performing (310) a three-way authentication process between the first node, the second node, and the authentication bridge to authenticate the first node to the wireless network. Illustrative details for implementing the method 300 will next be described by further reference to a specific implementation illustrated in FIG. 4, with the node 104 (the first node) attempting to authenticate to the node 124 (the second node).

At 302, the node 104 receives broadcast messages (e.g., 402, 404) sent by other nodes in the networks 110 and 120. Generally, in accordance with the teachings herein, any node that is either outside or inside the wireless network 110 or the wireless network 120 broadcasts messages that include at least an indication of its own cryptographic secrets. In one illustrative implementation, the messages 402, 404 comprise a beacon frame such as one described in the 802.11 family of standard protocols published by the Institute of Electrical and Electronic Engineers (IEEE). The indication of cryptographic secrets contained in each broadcast message includes at the least an indication of a trust anchor or a key or both for the broadcasting node 124. For 802.11 beacon frames, the indication of cryptographic secrets can be included in an information element (IE) in the beacon frame, for instance in a Robust Security Network (RSN) IE or a proprietary IE. If the node can authenticate to multiple networks it will have cryptographic secrets and corresponding indications thereof for each network, which it broadcasts to other nodes.

A trust anchor is a trusted entity that issues digital certificates to a user or computer whose identity it has verified so that other users and computers can rely on the authenticity of the certificate holder's identity. A trust anchor is also known as Certificate Authority (CA), which is used, for example, in networks implementing Secure Socket Layer (SSL) protocol and Public Key Infrastructure (PKI) framework to secure the network. The indication of the trust anchor can be a text name, domain name or distinguished name for a CA, a public key for the CA, a certificate for the CA including a self-signed certificate, a subset of the name or of the certificate including the self-signed certificate that is sufficient to identify the CA, or a hash function of any of the above described indications of the trust anchors or any combination of the above described indications of the trust anchors. A key can be a public or private key. Further, the indication of the key can be a public key corresponding to a private key, a hash of the public key, a name of the public key, a one-way hash function of a secret key value, or a name of a secret key or any combination thereof.

Returning again to method 300, at 302, the node 104 detects that one of these broadcast messages (e.g., 402) is from the node 124. The node 104 identifies the indication of cryptographic secrets for the node 124 contained in the broadcast message, and determines based on such indications whether it can perform mutual authentication directly with the node 124. In one implementation, the node (and other nodes as well) store a mapping of its own cryptographic secrets to one or more corresponding indications of its own cryptographic secrets. So when it detects the indication(s) of cryptographic secrets from other nodes (in this case the node 124), it can perform a comparison. Based on the comparison, the node determines whether it shares the proper credentials with another node (e.g., the node 124) to mutually authenticate with that node. If yes, then at 306, the node 104 mutually authenticates to the node 124. In one implementation, mutual authentication between the node 104 and the node 124 is performed by using extensible authentication protocol over local area network EAPOL frames (defined in IEEE 802.1X) and an 802.11 four-way handshake. However, mutual authentication is not limited to using such a protocol.

When the node 104 is not able to mutually authenticate with the node 124, at 308, the node 124 locates a node that can serve as an authentication bridge. To locate an authentication bridge, the node 104 starts detecting broadcast messages from nodes other than the node 124. In this case, the node 104 detects a broadcast message 404 from another node. Upon receiving the broadcast message 404, the node 104 determines that the indication of cryptographic secrets contained therein matches with indications of cryptographic secrets for both the node 104 and the node 124. This indicates that the node has shared cryptographic secrets to enable the node to mutually authenticate to both the node 104 and the node 124 and, thus, serve as an authentication bridge for the nodes.

In an embodiment, the node broadcasting the message 404 and other broadcasting nodes are first hop neighbor nodes of the node 104 and/or of the node 124. However, in another embodiment, the broadcasting nodes could be any node operating in any wireless network with a condition that their broadcast messages are received by the node 104 or by the node 124. Moreover, in one implementation, not only does a node store its own indication of cryptographic secrets, it can participate as a “forwarding node” and store an indication of cryptographic secrets of one of more of its neighbor nodes. For example, the node 124 could store a list of indications of cryptographic secrets of its neighbor nodes and include the indication of cryptographic secrets of its neighbor nodes in the message 402. Such inclusion can facilitate the location of an authentication bridge in case the node 104 cannot authenticate directly with the node 124.

After a node is located that can serve as an authentication bridge, the node 104 sends an Authentication Proxy Request (APR) message (406) to that node. The APR message lists both sets of indication of cryptographic secrets of the node 104 and the node 124 and also comprises a request asking the node to serve as an authentication bridge. The node sends an APR response (408) indicating its willingness to serve as the authentication bridge. If the node declines, the node 104 searches for a new node that can serve as the authentication bridge. The search includes the node 104 scanning other broadcast messages to locate the new node.

Where the APR response from the node is positive, the node 104 sends an Authentication Proxy Indication (API) message (410) to the node 124 indicating that a node has been found that is willing to serve as an authentication bridge and also probing the node 124 as to whether the node agrees to participate in a three-way authentication, wherein the authentication bridge assists the node 104 to authenticate to the node 124 and to the wireless network 120. In response to the API message, the node 124 sends an API Reply (412) to the node 104. When the API Reply (412) is positive, the three-way authentication process is performed, at 310, between the node 104, the node 124, and the authentication bridge.

During the process of the three-way authentication, the node 124 mutually authenticates (414) with the authentication bridge. The authentication bridge then sends (418) keying material to the node 124, wherein the keying material includes the security credentials needed by the node 124 to mutually authenticate to the node 104. Similarly, the node 104 mutually authenticates (416) to the authentication bridge and receives (420) the shared keying material from the authentication bridge. It should be noted that the nodes 104 and 124 mutually authenticating to the authentication bridges guards against keying materials been sent to imposters in the network. Now, the nodes 104 and 124 have the proper security credentials to perform the mutual authentication (422) that authenticates the node 104 to the network 120.

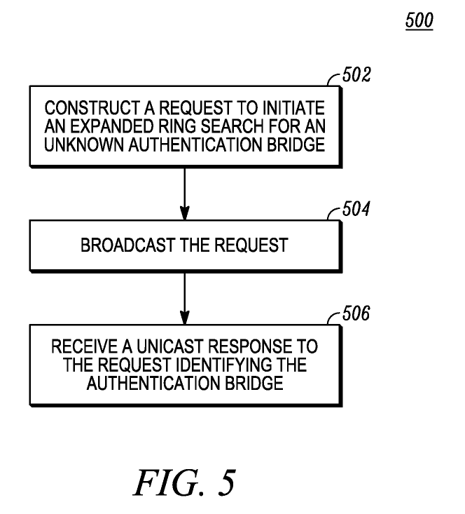

In the above illustrative implementation, the node 104 located the authentication bridge from the broadcast message (404) that it received from that node. However, in some cases, the node 104 is unable to detect the broadcast messages of a suitable authentication bridge and, thereby, locate this node because the node is a few (e.g., two or more) hops away from the node 104. In this scenario, the authentication bridge can be located by performing an expanded ring search. In one implementation where the identity of an authentication bridge is known, as in the case where the node 104 is aware of a server (via, e.g., a server identification (ID) or server address) that could serve as an authentication bridge, a known expanded ring search method could be used to locate the authentication bridge. However, when the node 104 does not know the entity that can serve as the authentication bridge, an expanded ring search can be performed in accordance with the teachings herein and as described by reference to FIG. 5. In general, method 500 comprises: constructing (502) a request to initiate an expanded ring search for an unknown authentication bridge; broadcasting (504) the request to all nodes that are operating either inside or outside a wireless network; receiving (506) a response to the request. Illustrative details for implementing the method 500 will next be described.

At 502, the node 104 constructs a request to initiate an expanded ring search for locating an unknown node that can serve as an authentication bridge. The node 104 initiates the expanded ring search because it is not able to mutually authenticate directly with the node 124 and cannot locate an authentication bridge via broadcast messages that it receives. The request probes the unknown node for its willingness to serve as an authentication bridge. The request comprises at least a parameter used to identify a node to serve as the authentication bridge. For example, the at least one parameter may include an indication of cryptographic secrets for the node 104 and generally also includes an indication of cryptographic secrets for the node 124, i.e., the node to which the node 104 desires to authenticate. The request can also include an address (e.g., an Internet Protocol (IP) address) for the originator of the request to facilitate a unicast response from the authentication bridge directly to the originating node.

At 504, the node 104 broadcasts the request to all its neighbor nodes. Accordingly, the request sent by the node 104 reaches its first-hop neighbor nodes. If any of the first-hop neighbor nodes determine that it cannot serve as the authentication bridge, then it forwards the request to its own first-hop neighbor nodes, wherein these first-hop neighbor nodes would be the second-hop neighbor nodes for the node 104. This process continues until a node is located with the proper security credentials to serve as the authentication bridge for the nodes 104 and 124. In addition, the request may also comprise the extent up to which the expanded ring search should proceed. For instance, the node 104 may limit the expanded ring search to three-hops from the node 104. When no authentication bridge is located within three hops from the node 104 in a given preset time period, the search may end or the node 104 might extend the request to include addition hops. This control helps to minimize additional traffic congestion in a system.

If the expanded ring search locates an authentication bridge that meets the parameters of the request, the node sends a response that is received (506) by the node 104. Where the address of the node 104 is included in request, the prospective authentication bridge can send a unicast response directly to the node 104. In an implementation, the request may further include a request for the receiving node to serve as the authentication bridge. Thus, the node sending a positive response to the request could avoid the need for the APR request/response message sequence, saving bandwidth.

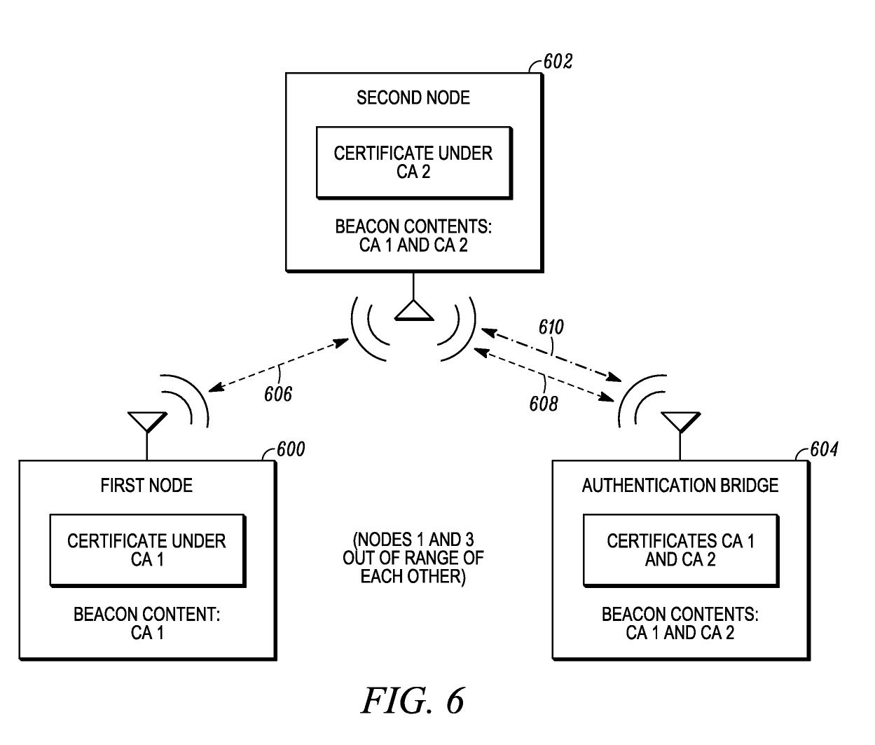

In the above illustrative implementation, it was assumed that both the nodes 104 and 124 were within range of the authentication bridge so that each node could directly mutually authenticate with the authentication bridge. However, this is not always the case. In some scenarios only one of the nodes is within transmission range of the authentication bridge. In such a case, a process illustrated by reference to a block diagram 600 in FIG. 6 may be used, wherein the node within range of the authentication bridge facilitates the mutual authentication between the other node and the authentication bridge.

Accordingly, FIG. 6 illustrates a first node 600, a second node 602 and third node 604. The node 600 desires to mutually authenticate to the node 602 to authenticate to a network in which the node 602 operates. Node 600 has a certificate signed by a trust anchor CA1, and its beacon content comprise an indication of CA1. Node 602 has a certificate signed by a trust anchor CA2, and its beacon content comprise an indication of CA2. The node 604 has a certificate signed by the trust anchor CA1 and a certificate signed by the trust anchor CA2, and its beacon content comprise an indication of CA1 and of CA2. In this implementation, the beacon contents of the node 602 further comprise the indication of CA1 for the node 604.

It is assumed for purposes of this illustration that via contents of the beacon message that the node 602 broadcasts, the node 600 determined that it cannot directly mutually authentication with the node 600 because they do not share the same security credentials (i.e., trust anchors), and that it needs to locate an authentication bridge. However, since the beacon contents from the node 602 further contain the security credentials of the node 604, the node 600 determined that the node 604 has the proper security credentials (i.e., certificates signed by both the CA1 and the CA2) to serve as the authentication bridge for the nodes 600 and 602.

However, only node 602 is in transmission range of the node 604. Therefore, in accordance with the teachings herein by reference to FIG. 6, the node 600 uses the node 602 to relay messages using any suitable relay protocol (e.g., an 802.1X Relay protocol) in order to request that the node 604 serve as the authentication bridge and if a positive response is obtained to complete the three-way authentication process with the node 604 and obtain the keying material needed to mutually authenticate with the node 602. More particularly, the node 600 initiates an authentication process by sending (606) an authentication message (e.g., an APR message) that is relayed (608) by the node 602 to the node 604 using, e.g., the 802.1X Relay protocol. Using this protocol, authentication messages are forwarded in authentication frames such as EAPOL frames. All other authentication messages between the node 600 and the node 604 are likewise relayed through the node 602 until mutual authentication has been completed between the nodes 600 and 604 and the node 600 has received the keying material (e.g., a Pairwise Master Key (PMK)) to mutually authenticate to the node 602 to join the network. The node 602 likewise mutually authenticates (610) with the authentication node 604 to receive the shared keying material. However, this could have already been done prior to the node 600 attempting to join the network. Since both the nodes 600 and 602 now have the PMK, they can mutually authenticate to join the node 600 to the network. In an example, all mutual authentication is performed using an 802.11 four-way handshake process, although this is not a required protocol.

In the implementation described above, node 600 identifies the node 604 as a possible authentication bridge from the beacons that the node 602 broadcasts. However, it is not necessary for the node 602 to disclose which trust anchors to which it is associated. In this scenario, the node 600 would initiate authentication with the node 602, and the node 602 would locate the node 604 to serve as the authentication bridge and send an authentication request to the node 604. When all three nodes have agreed upon the three-way authentication, it is performed so that ultimately the node 600 is authenticated to the network. It should be understood that in an alternative scenario, the node 602 could be out of range of the authentication bridge 604 and the node 600 within the range of the node 604. In such a case, the node 600 uses the relay protocol to relay authentication messages between the node 602 and 604 to authenticate the node 600 to the network.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim

1. A method for authenticating a first node to a communication network that includes a second node to which the first node desires to mutually authenticate, the method comprising:
detecting a first broadcast message from the second node, wherein the first broadcast message comprises an indication of cryptographic secrets, which includes an indication of at least one of a trust anchor or a key for the second node;
using the indication of cryptographic secrets to determine whether mutual authentication can be performed directly with the second node;
when mutual authentication can be performed directly with the second node, initiating the mutual authentication to authenticate the first node to the communication network.

2. The method of claim 1, further comprising locating a third node to serve as an authentication bridge to authenticate the first node to the communication network when mutual authentication cannot be performed directly with the second node,

3. The method of claim 2, wherein locating the third node comprises:
receiving a second broadcast message comprising an indication of cryptographic secrets for the third node;
determining that the indication of cryptographic secrets in the second broadcast message matches an indication of cryptographic secrets for both the first node and the second node.

4. The method of claim 3, wherein the second broadcast message is sent by one of:
the third node, which is a neighbor node to the first node; or
a fourth node, which is a neighbor to both the first node and the third node.

5. The method of claim 2, wherein the first node sends at least one of an Authentication Proxy Request message to the third node or an Authentication Proxy Indication message to the second node to initiate authenticating the first node to the communication network.

6. The method of claim 2, wherein locating the third node comprises initiating an expanded ring search by broadcasting a message that includes an address for the first node and at least one parameter to locate an unknown node to serve as the authentication bridge.

7. The method of claim 6, further comprising receiving a response message using the address for the first node, wherein the response message identifies the third node as the authentication bridge.

8. The method of claim 2, wherein the third node serving as the authentication bridge comprises:
both the first node and the second node directly mutually authenticating to the third node to receive keying material used to authenticate the first node to the communication network.

9. The method of claim 2, wherein the third node serving as the authentication bridge comprises:
the first node directly mutually authenticating to the third node to receive keying material and the second node mutually authenticating to the third node via the first node using a relay protocol, to receive the keying material used to authenticate the first node to the communication network.

10. The method of claim 2, wherein the third node is a plurality of hops away from the first node and the second node, and the third node serving as the authentication bridge comprises the first node and the second node exchanging messages with the third node to receive keying material used to authenticate the first node to the communication network.

11. The method of claim 1, wherein the first broadcast message comprises a beacon frame that includes an information element, which contains the indication of cryptographic secrets for the second node.

12. The method of claim 1, wherein the indication of the trust anchor comprises at least one of: a name for a certification authority (CA), a subset of the name for the CA, a hash function of the name for the CA, a public key for the CA, a hash function of the public key for the CA, a certificate for the CA, a subset of the certificate for the CA, or a hash function of the certificate for the CA.

13. The method of claim 1, wherein the indication of the key comprises at least one of a public key corresponding to a private key, a hash of the public key, a name of the public key, a one-way hash function of a secret key value, or a name of a secret key.

14. A method for locating an authentication bridge to authenticate a first node to a communication network, the method comprising:
constructing a request for an unknown authentication bridge, the request comprising at least a parameter for the first node that is used to identify a second node to serve as the authentication bridge to authenticate the first node to the communication network;
broadcasting the request;
receiving a response to the request, wherein the response identifies the second node as the authentication bridge.

15. The method of claim 14, wherein the parameter comprises an indication of cryptographic secrets for the first node, wherein the indication of cryptographic secrets includes an indication of least one of a trust anchor or a key.

16. The method of claim 15, wherein the request further comprises an indication of cryptographic secrets for a third node that is used to identify the second node.

17. A method for authenticating a first node to a communication network, the method comprising:
broadcasting a message to a plurality of nodes, wherein the message comprises an indication of cryptographic secrets, which includes an indication of at least one of a trust anchor or a key;
receiving an authentication request from a first node;
providing a response to the authentication request to assist the first node in authenticating to the communication network.

18. The method of claim 17, wherein the message is broadcast by a second node in the communication network to which the first node directly mutually authenticates to authenticate to the communication network.

19. The method of claim 17, wherein the message is broadcast by a second node that serves as an authentication bridge to authenticate the first node to the communication network using a three-way authentication process that includes the first node, the second node and a third node in the communication network to which the first node mutually authenticates upon the first node and the third node receiving keying material from the second node.

20. The method of claim 19, wherein the second node is a neighbor to the first node or is located by an expanded ring search.
